(19) United States
(12) Patent Application Publication
(10) Pub. No.: US 2002/0112063 A1
(43) Pub. Date: Aug. 15, 2002

(54) Methods, systems and computer program products for requesting wireless telephony application (WTA) protocol based actions

(76) Inventors: Jonathan Lohr, Raleigh, NC (US); Gregory Dunko, Cary, NC (US)

Correspondence Address: MYERS BIGEL SIBLEY & SAJOVEC, PO BOX 37428, RALEIGH, NC, 27627, US

(21) Appl. No.: 09/782,834

(22) Filed: Feb. 14, 2001

(51) Int. Cl. G06F 15/16

(52) U.S. Cl. 709/230

(57) ABSTRACT

Methods, systems and computer program products are provided for requesting WTA protocol based actions. A request may be received for execution of the WTA protocol based action by a target mobile terminal that has a WTA agent. The request may include an identification code that identifies a destination device for the WTA protocol based action. The identification code that identifies the destination device may then be associated with a Uniform Resource Locator (URL). A push command including the URL may be generated at a server. The push command may then be transmitted to the target mobile terminal to initiate the requested WTA protocol based action by the WTA agent of the target mobile terminal. The WTA protocol based action may involve initiation of a call from the target mobile terminal to the destination device or repeatedly initiating calls from the target mobile device. The URL may or may not be associated with the identification code and the WTA protocol based action may or may not involve automatically accepting a call at the target mobile terminal.

### BACKGROUND OF THE INVENTION

The present invention relates to Wireless Communications and, more particularly, to requesting Wireless Telephony Application (WTA) Protocol based communications.

The desire of individuals to contact others quickly and frequently has been addressed by a variety of telephony functions in the past. For example, a modern phone is typically equipped with a redial function which allows you to call the last person you called by touching a single button. More recently, phones have been equipped with a caller identification (ID) function. This function typically allows the incoming phone number to be displayed on some sort of screen along with some summary information about the incoming phone number, for example, the name of the person who owns the phone, the location of the phone, etc. More advanced versions of the caller ID function may keep a list of all the incoming calls received and allow these calls to be returned by touching a single button. Many modern phones are also equipped with a one touch dialing system in which a phone number may be programmed into a phone and assigned to a particular button on the face of the phone, allowing the user to access the number by touching a single button. Furthermore, many features offered by telephony service providers offer users the opportunity to contact others quickly and frequently. For example, *69 allows a user to obtain the phone number of the last person that called their telephone number and return the call by pushing a single button on the phone.

Many of these features are useful, for example, for parents seeking to keep track of their children. In this age of mobile phones, pagers, etc. parents may have the ability to contact their children at any time with a touch of a button. Parents may also take advantage of features like caller ID and *69 to make sure their children are being truthful as to their location. These modern conveniences do have their limits. Often times a child may not call when he is supposed to or may not answer his phone to avoid speaking with the child's parents. In these situations it may be difficult for a parent to keep track of the child even if the child does have a mobile phone or a pager.

### SUMMARY OF THE INVENTION

The present invention provides methods, systems and computer program products for requesting WTA protocol based actions. A request is received for execution of the WTA protocol based action by a target mobile terminal that has a WTA agent. The request may include an identification code that identifies a destination device for the WTA protocol based action. The identification code that identifies the destination device may be associated with a Uniform Resource Locator (URL). A push command including the URL may be generated at a server. The push command is transmitted to the target mobile terminal to initiate the requested WTA protocol based action by the WTA agent of the target mobile terminal. In some embodiments of the invention, the WTA protocol based action may involve initiation of a call from the target mobile terminal to the destination device or repeatedly initiating calls from the target mobile device. Other embodiments need not associate the URL with the identification code. In these embodiments, the WTA protocol based action may involve automatically accepting a call at the target mobile terminal.

### BRIEF DESCRIPTION OF THE DRAWINGS

FIG. 1 is a block diagram of the Wireless Telephony Application (WTA) Protocol architecture.

FIG. 2 is a block diagram of embodiments of the present invention implemented in a network environment.

FIG. 3 is a block diagram of a mobile terminal according to embodiments of the present invention.

FIG. 4 is a block diagram of a system according to embodiments of the present invention.

FIG. 5 is a flowchart illustrating operations for requesting WTA protocol based actions according to embodiments of the present invention.

FIG. 6 is a flowchart illustrating operations for requesting WTA protocol based actions according to further embodiments of the present invention.

FIG. 7 is a flow diagram illustrating operations for requesting WTA protocol based actions according to other embodiments of the present invention.

FIG. 8 is a block diagram of a system according to embodiments of the present invention.

FIG. 9 is a flowchart illustrating operations for requesting WTA protocol based actions according to embodiments of the present invention.

FIG. 10 is a flowchart illustrating operations for requesting WTA protocol based actions according to further embodiments of the present invention.

FIG. 11 is a flow diagram illustrating operations for requesting WTA protocol based actions according to other embodiments of the present invention.

### DETAILED DESCRIPTION OF THE INVENTION

The present invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As will be appreciated by one of skill in the art, the present invention may be embodied as a method, system, or computer program product. Accordingly, the present invention may take the form of an entirely hardware embodiment, an entirely software embodiment or an embodiment combining software and hardware aspects. Furthermore, the present invention may take the form of a computer program product on a computer-usable storage medium having computer-usable program code means embodied in the medium. Any suitable computer readable medium may be utilized including hard disks, CD-ROMs, optical storage devices, a transmission media, such as those supporting the Internet or an intranet, or magnetic storage devices.

Computer program code for carrying out operations of the present invention may be written in an object oriented programming language such as Java®, Smalltalk or C++. However, the computer program code for carrying out operations of the present invention may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function or act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions or acts specified in the flowchart and/or block diagram block or blocks.

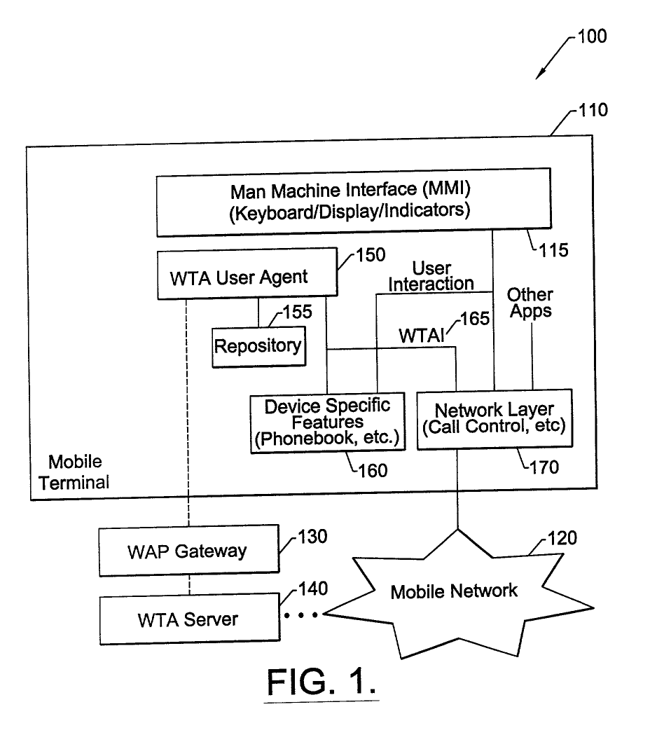

By way of background to understanding the present invention, FIG. 1 is a block diagram which illustrates the Wireless Telephony Application (WTA) Protocol architecture. The architecture 100 includes a mobile terminal 110, a mobile network 120, a Wireless Application Protocol (WAP) gateway 130, and a WTA server 140. For the illustrated embodiments, a WTA server 140 is coupled to the wireless network 120, such as a cellular telecommunications network, through the WAP gateway 130. A mobile terminal 110 communicates over a wireless connection to the wireless network 120. Thus, the wireless network 120 may provide a connection between the mobile terminal 110 and the WTA server 140 through the WAP gateway 130.

WTA provides an application framework for telephony services. The WTA framework may support Wireless Telephony Applications that interface with device specific features 160 located within the mobile terminal 110 and the network telephony infrastructure (network layer 170). As shown in FIG. 1, the mobile terminal 110 is typically equipped with a dedicated WTA user-agent 150. The WTA user-agent 150 may retrieve content from a repository 155 and Wireless Telephony Application Interface (WTAI) 165 Libraries. The WTAI 165 libraries may contain functions which may provide the WTA user-agent 150 access to device specific functions 160, such as a phonebook, and/or to mobile network functions, such as setting up calls (network layer 170). The mobile terminal 110 may also be equipped with the standard devices such as a Man Machine Interface (MMI) 115 which may include, for example, a keyboard, a display, etc.

WAP is generally a specialized application protocol that has been tailored for small handheld communication devices, like cellular phones, that may have limited keypad entry and display capabilities. WAP defines a set of protocols in the transport, session and application layers of a protocol stack. The WTA utilities of WAP may provide the additional capabilities for interfacing with mobile network services available to a mobile telephony device, such as setting up and receiving (accepting) telephone calls. These additional capabilities typically utilize the WTA user-agent 150. The standard user-agent (Wireless Application Environment (WAE) user-agent) may be capable of interfacing with WTAI 165 public library functions, such as the ability to place a call, but does not generally allow full featured telephony control. Typically, only the WTA user-agent is able to fully control the telephony features of a mobile telephony device, such as a mobile terminal 110. For example, the WAE user-agent may not be able to receive and react to telephony and network text events. The WAE user-agent may only retrieve its content through the WAP gateway 130 and may only have access to the WTAI 165 public library functions. As stated above, the WTA user-agent 150 generally may retrieve content from the repository 155 and has access to all WTAI 165 libraries, both public and private.

The WAP Gateway 130 may be used to translate WAP messages into other protocols so that the WAP messages may be accessible to other types of applications. The WTA server 140 may communicate with the mobile network 120 through the WAP gateway 130. The WTA Server 140 may be a web server that may deliver content requested by a WTA equipped mobile terminal 110. A WTA user-agent 150 may use Uniform Resource Locators (URLs) to reference content on the WTA server 140. A URL may also be used to reference an application on a web server that is executed when referenced. Such applications may be programmed to perform a wide range of tasks. Referencing these applications on the WTA server 140 may make it possible to create services that use URLs to interact with the mobile network 120 and other entities.

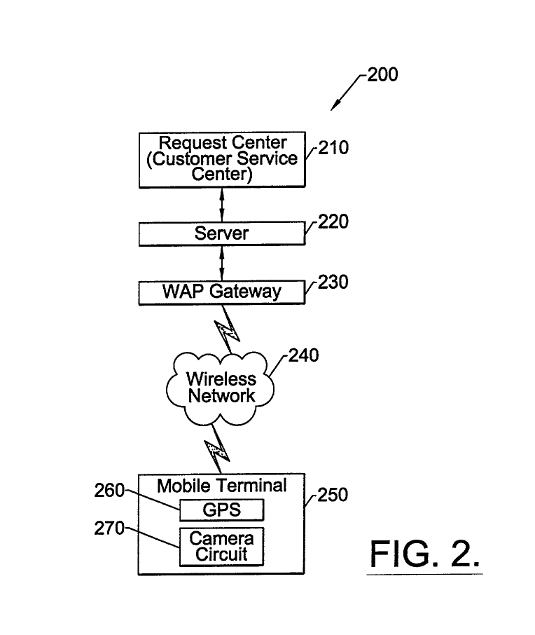

Referring now to FIG. 2, a block diagram of embodiments of the present invention implemented in a network environment will be described. The network 200 may include a mobile terminal 250, a wireless network 240, a WAP Gateway 230, a server 220 and a request center 210. The server 220 may communicate with a wireless network 240 over the wireless connection through the WAP gateway. The mobile terminal 250 may communicate over a wireless connection of the wireless network 240. Thus, the wireless network 240 may provide a connection between the mobile terminal 250 and the server 220 through the WAP gateway 230.

The network as illustrated in FIG. 2, also includes a request center 210. This request center 210 may be a customer service center or the like. This request center 210 may communicate user requests to the server 220. The server 220 may include a WTA server 140, as discussed above, or a general applications server. The type of server employed may be determined by the type of function requested. For example, if the function requested may be accessed in the WTAI 165 public library, as discussed above, then a general applications server may be used. If, on the other hand, the function requires access to one of the WTAI 165 private libraries a WTA server 140 may be used.

Once the request has been processed by the server 220, the server 220 may communicate the request over a wireless connection of the wireless network 240 through the WAP gateway 230. The WAP gateway, as discussed above, may translate WAP messages into the protocol (language) of the receiving device. The mobile terminal 250 may receive the request from the wireless network 240 over a wireless connection. If the request requires the mobile terminal 250 to perform some function, the mobile terminal 250 may perform the requested function responsive to the request. The type of functions that may be requested may include, for example, initiating a phone call from the target mobile terminal, accepting a call at the target mobile terminal, providing a location responsive to the Global Positioning System (GPS) 260 functionality of the mobile terminal 250 and/or providing a digital image/responsive to a camera circuit 270 associated with the mobile terminal 250.

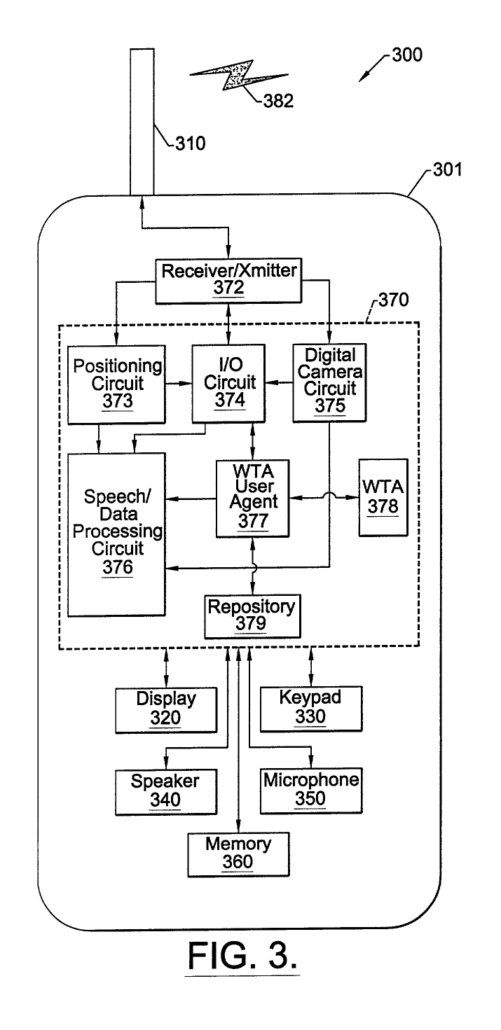

FIG. 3 illustrates an exemplary mobile terminal 300, such as a wireless mobile terminal, according to embodiments of the present invention. The mobile terminal 300 may include, in a housing 301, a transceiver (i.e., receiver and transmitter) 372 that is operative to transmit and receive RF communication signals via an antenna 310 under control of a controller 370. The controller 370 may include a speech/data processing circuit 376 as well as other functional modules not illustrated in FIG. 3 but which will be understood to those of skill in the art related to wireless communications including both data and voice communication support. As used herein, the speech/data processing circuit 376 may include components such as demodulators, decoders, interleavers and RF processor circuitry.

The controller 370, such as a microprocessor, microcontroller or similar data processing device, may execute program instructions stored in a memory 360 of the mobile terminal 300, such as a dynamic random access memory (DRAM), electrically erasable programmable read-only memory (EEPROM) or other storage device. The controller 370 is further operatively associated with user interface components of the mobile terminal 300 such as a display 320, a keypad 330, a speaker 340, and a microphone 350, operations of which are known to those of skill in the art and will not be further discussed herein.

The transceiver 372 may provide a communication circuit including a receiver that receives wireless communications 382 from a server, such as the WTA server 140, and may further receive location system signals from a land based system or from GPS satellites. The transceiver 372 may further operate to provide such signals from the location system to the positioning circuit 373 and from the server to the I/O circuit 374.

The positioning circuit 373 is configured to determine a location of the mobile terminal. The positioning circuit 373 may determine a location of the mobile terminal 300, for example, using signals from GPS satellites. In alternative embodiments, a land based automated positioning system configured to determine the location of the mobile terminal based on wireless communications between the mobile terminal 300 and the land based automated positioning system may be utilized by the positioning circuit 373 to allow the mobile terminal 300 to determine its location. It is to be understood that, as used herein, “GPS” is intended to encompass not only the United States satellite based system commonly using such designation but similar systems, such as Glonass, or other subsequently developed satellite based location systems. Furthermore, as used herein, “land based automated positioning system” is intended to encompass hybrid systems including satellite components.

The digital camera circuit 375, in cooperation with the I/O circuit 374 and the transceiver 372, may be configured to transmit data such as a digital photograph to the server over a connection between the mobile terminal 300 and the server. The I/O circuit 374, in cooperation with the transceiver 372, may be further configured to communicate with a WTA user-agent 377 having access to a repository 379 and WTAI libraries 378. The I/O circuit 374 may be further configured to receive information from the server for the WTA user-agent 377 and transmit information from the WTA user-agent 377 to the server.

It will be appreciated that the transceiver 372, the speech/data processing circuit 376 and other components of the mobile terminal 300 may be implemented using a variety of hardware and software. For example, operations of the transceiver 372 and/or the speech/data processing circuit 376 may be implemented using special-purpose hardware, such as an application specific integrated circuit (ASIC) and programmable logic devices such as gate arrays, and/or software or firmware running on a computing device such as a microprocessor, microcontroller or digital signal processor (DSP). It will also be appreciated that, although functions of the transceiver 372 and the other circuits shown in FIG. 3 may be integrated in a single device, such as a single ASIC microprocessor, they may also be distributed among several devices. Aspects of these circuits may also be combined in one or more devices, such as an ASIC, DSP, microprocessor or microcontroller. These various implementations using hardware, software, or a combination of hardware and software will generally be referred to herein as “circuits.”

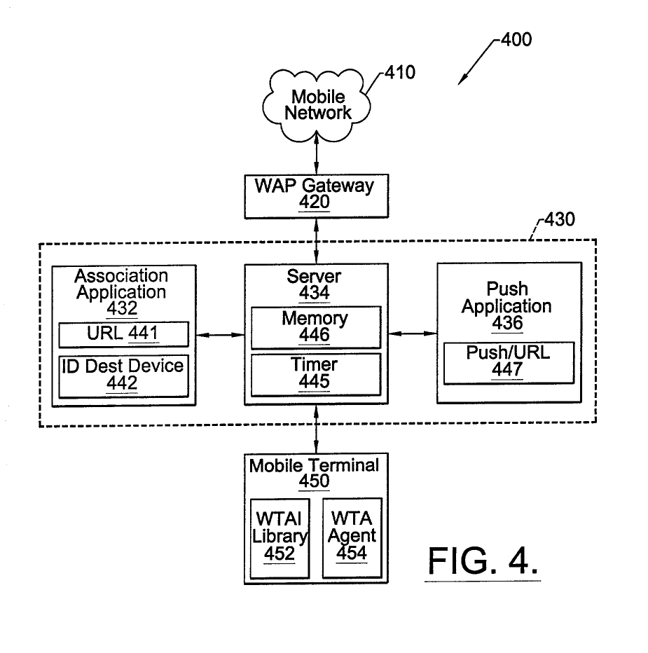

The present invention will now be further described with reference to the block diagram of FIG. 4 which illustrates a system 400 according to embodiments of the present invention. As illustrated in FIG. 4, the system includes a server 430 which includes an applications server 434, a push application 436 and an association application 432. Although the server 430 is shown as one physical component made up of three internal applications 432, 434, and 436 in FIG. 4, it will be understood by those having skill in the art that this arrangement is for exemplary purposes only and that many configurations may be employed. For example, two physically separate servers may be employed, a WTA server and an applications server, each having their respective functions and applications 432 and 436 can be combined with the applications server 434.

The applications server 434 may receive a request for a WTA protocol based action by a target mobile terminal. The request may arrive from one of many sources, for example, from a mobile terminal, from a Public Switched Telephone Network (PSTN) phone, from a source on the internet, or the like. In embodiments of the present invention the request may be to initiate a call from a target mobile terminal to another mobile terminal or other destination device. If this is the case, the request may include the contact number of the target mobile terminal and the identification code that identifies the destination device. The identification code that identifies the destination device may be the contact number of the destination device. These contact numbers may be mobile telephone numbers, PSTN telephone numbers, or the like. In other embodiments the request may be for repeatedly calling the destination device. If this is the case, the request may also include a start time of the first call, an interval that specifies when the subsequent calls are to occur, and an indication of when the calls should terminate. This information may be processed by the applications server 434. The applications server 434 may contain computer programs that may be used to process the request and a memory 446 for storage of URLs and scripts.

Typically it is desirable to have a secure relationship between the device that makes the request and the server 434. This may be provided by limiting access to the means of requesting the WTA protocol based action by the target mobile terminal. The processes for securing a connection in a wireless network are known to those of skill in the art and will not be discussed further herein.

The association application 432 may create a unique association of the contact number (identification code) that identifies the destination device 442 with a Uniform Resource Locator (URL) 441. This unique association may be used by the target mobile terminal to initiate contact with the destination device. The URL 441 may, for example, reference a script that triggers a make call process in the WTA user-agent 454 of the target mobile terminal 450. The make call process may be located in the WTAI public library 452. Where the make call process is in the WTAI public library 452 the WTA server need not be used to access this function, the make call function may, alternatively, be accessed by a general applications server 434.

The start time of the first call, an interval that specifies when the subsequent calls should occur, and the indication of when the calls should terminate may be processed by the applications server 434. The applications server 434 may contain the timer 445 and the ability to perform these functions. The push application 436 creates the push command 447 that is typically needed to initiate the make call process. The push command may contain the URL as described above.

When the timer 445 reaches the start time indicated in the request for the WTA protocol based action, the applications server 434 may trigger the transmission of the push command 447, previously created by the push application 436, including the URL associated with the identification code that identifies the destination device. The push command may be transmitted to the WTA agent 454 of the target mobile terminal 450. The WTA user-agent may use the URL to reference the make call function in the WTAI public library 452. This is the same URL that has been associated with the identification code of the destination device, therefore the WTA user-agent 454 may initiate a call from the target mobile terminal 450 to the destination device. The communication between the server 430 and the mobile terminal 450 may be through the mobile network 410 via the WAP gateway 420 although it is shown as direct in FIG. 4 to simplify the illustration.

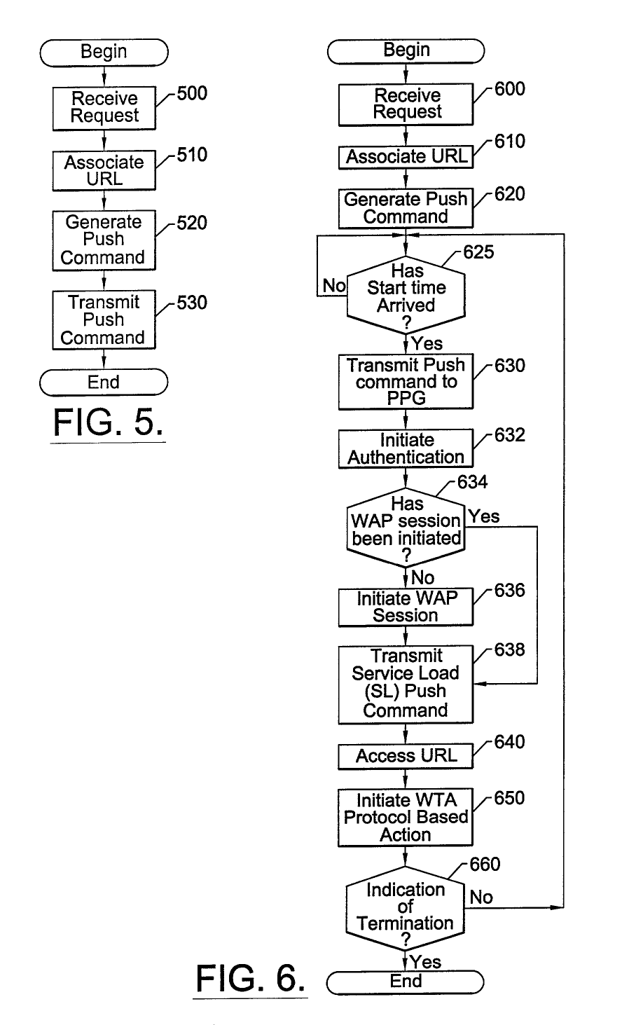

Operations according to embodiments of the present invention for requesting WTA protocol based actions will now be further described with reference to the flow chart illustration of FIG. 5. Operations begin at block 500 with receipt of a request for execution of the WTA protocol based action by a target mobile terminal having a WTA user-agent. This request may be received, for example, from a mobile terminal, a PSTN phone, a source on the internet, or the like. In embodiments of the present invention the WTA protocol based action may be the initiation of a call from the target mobile terminal to the destination device. If this is the case, the request may include the identification code of the destination device and a contact number of the target mobile terminal. The identification code of the destination device may be the contact number of the destination device. The WTA protocol based action may also be for successive initiations of calls from the target mobile terminal to the destination device. If this is the case, the request may further include a start time for the first call, an interval on which the calls should execute, and an indication of when execution of the calls should terminate. The interval may be a periodic interval but does not have to be periodic. The interval may be specified by the request for execution of the WTA protocol based action. The indication of when execution of the calls should terminate may be in the form of a stop time, a number of calls to be made, or other interval specification.

A server receiving a request for execution of the WTA protocol based action by a target mobile terminal may associate a Uniform Resource Locator (URL) with the identification code that identifies the destination device (block 510). As discussed above, this is a unique association that may be used by the target mobile terminal to initiate contact with the destination device. The URL may reference a script that triggers a make call process in the WTA user-agent 454 of the target mobile terminal 450. The make call process may be located in the WTAI public library 452. The fact that the make call process is provided in the WTAI public library 452 may allow the make call function to be accessed by a general applications server not just a WTA server. Accordingly, the applications server 434 may be a WTA server, a general applications server, or the applications server may be incorporated into the WTA server.

A push command, including the associated URL, is generated at the server (block 520). The push command may further include a pointer to a Push Proxy Gateway (PPG) of the target mobile terminal, an identifier of a contact number of the target mobile terminal, and a pointer to the WTA user agent of the target mobile terminal. The push command may be transmitted to the target mobile terminal to initiate the requested WTA protocol based action by the WTA agent of the target mobile terminal (block 530). If, as discussed above, the WTA protocol based action is successive initiations of calls from the target mobile terminal to the destination device, the push command may be repeatedly transmitted according to the interval specified by the request for execution of the WTA protocol based action.

Operations according to embodiments of the present invention for requesting WTA protocol based actions, and in particular for transmitting a push command, will now be further described with reference to the flow chart illustration of FIG. 6. Operations begin at block 600 with receipt of a request for execution of the WTA protocol based action by a target mobile terminal having a WTA user-agent. A server receiving a request for execution of the WTA protocol based action by a target mobile terminal may associate a URL with the identification code that identifies the destination device (block 610). A push command including the associated URL is generated at the server (block 620). The details associated with blocks 600-620 are discussed in above with respect to blocks 500-520 of FIG. 5.

It is determined if the start time included in the request discussed above has arrived (block 625). If the start time has not arrived operations may remain at block 625 until the start time does arrive. If the start time has arrived, the push command, including the URL, is transmitted to the Push Proxy Gateway (PPG) of the target mobile terminal identified in the push command (block 630). The PPG may be located within the WAP Gateway. The PPG initiates an authentication between the server and the target mobile terminal (block 632). This may ensure that the appropriate security is in place to guarantee that the push command is from a trusted source.

The PPG determines if a Wireless Application Protocol (WAP) session has been initiated (block 634). If a WAP session has not been initiated, the PPG may initiate the WAP session (block 636). The PPG may initiate the WAP session by sending a Session Initiation Application (SIA) to the WTA user-agent of the target mobile terminal and the WTA agent may initiate the WAP session in response to the SIA. If the WAP session is already in progress (block 634), operations may proceed to block 638 where the PPG may transmit a Service Load (SL) push command including the URL to the WTA user agent of the target mobile terminal using the WAP session. The URL may be accessed by the WTA user-agent (block 640). As discussed above, the URL is associated with a script that executes a make call command associated with the WTAI public library. The target mobile terminal may initiate a call from the target mobile terminal to the destination device (block 650).

It is determined if an indication of termination has been identified (block 660). As discussed above, an indication of termination may be in the form of a stop time or a maximum number of calls to be made. If the stop time has arrived or the maximum number of calls has been reached, an indication of termination may have been identified and operations may be terminated. If an indication of termination has not been identified, operations may return to block 625 and repeat until an indication of termination is identified.

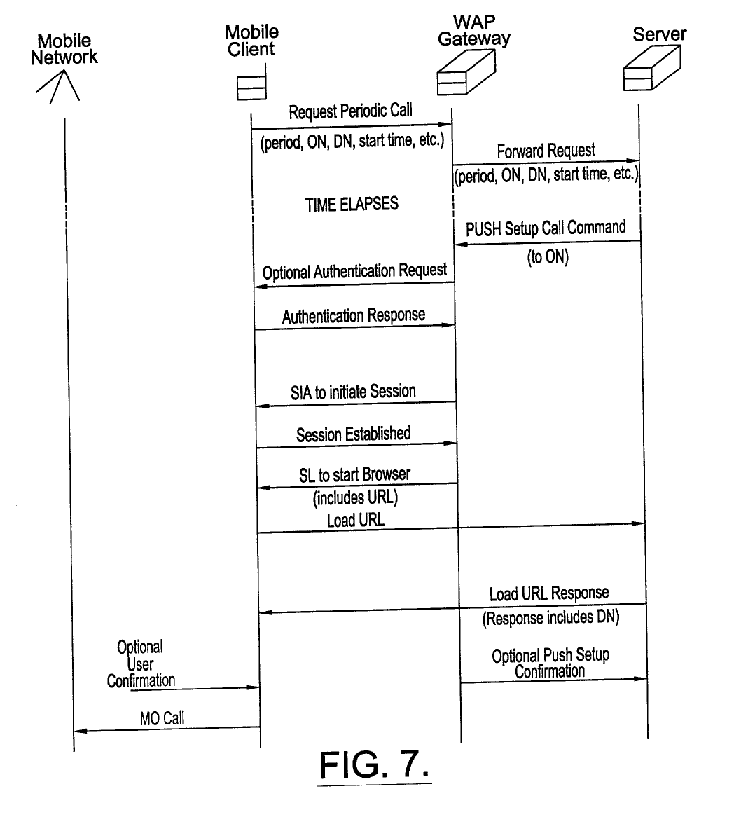

Operations according to embodiments of the present invention for requesting Wireless Telephony Application (WTA) protocol based actions are further illustrated in the flow diagram of FIG. 7. The flow diagram illustrates operations of embodiments of the present invention from receiving a request for WTA protocol based action through initiating the of the WTA protocol based action. The details of each of the steps illustrated in the flow diagram of FIG. 7 correspond to those described above with reference to FIGS. 5 and 6. FIG. 7 also illustrates a user confirmation and a push setup confirmation not described above with respect to FIGS. 5 and 6. These confirmations are optional as indicated in FIG. 7 and will not be discussed further herein.

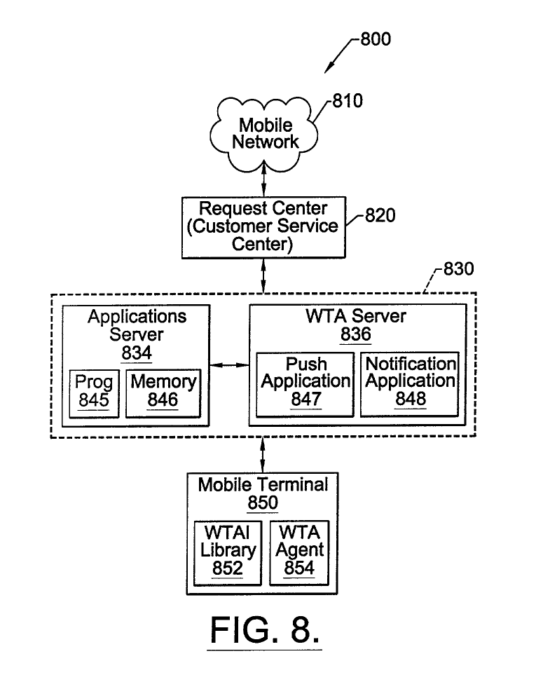

Other embodiments of the present invention will now be described with reference to the block diagram of FIG. 8 which illustrates a system 800 according to embodiments of the present invention. As illustrated in FIG. 8, the system includes a server 830 which includes an applications server 834 and a WTA server 836. Although the server 830 is shown as one physical component made up two internal servers 834 and 836, it will be understood by those having skill in the art that this is for exemplary purposes only and that many configurations may be employed. For example, two physically separate servers may be employed, a WTA server and an applications server, each having their respective functions. Alternatively, the applications server may be part of the request center (Customer Service Center (CSC)) 820 or part of the WTA server 836.

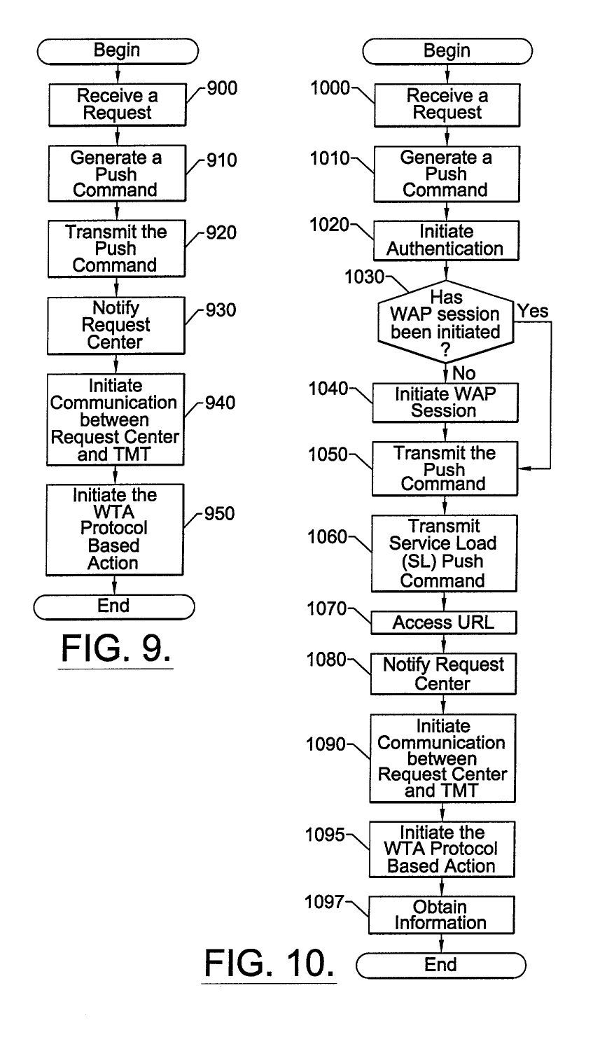

A user may send a request for a WTA protocol based action by a target mobile terminal to the CSC 820. The request may arrive from many sources, for example, from a mobile terminal, from a Public Switched Telephone Network (PSTN) phone, a source on the internet, or the like. The request may be for automatically accepting a call at the target mobile terminal, i.e. accepting a call without user intervention. If this is the case, the request may include the contact number of the target mobile terminal. This contact number may be a mobile telephone number, PSTN telephone number, or the like. This information may be processed by the applications server (receiving server) 834. The applications server 834 may contain computer programs 845 that may be used to process the request and coordinate the accepting of a call by the target mobile terminal and a memory 846 that may be used to store the information contained in the request. The coordination may involve requesting the call when the mobile terminal 850 is prepared to accept the call, as will be discussed further for various embodiments below with respect to FIGS. 9 and 10.

It may be desirable to have a secure relationship between the device that makes the request and the server 830. This may be provided by limiting access to the means of requesting the WTA protocol based action by the target mobile terminal. Process for securing a connection in a wireless network are known to those of skill in the art and will not be further discussed herein.

The applications server 834 may coordinate with the WTA server 836 to create a push command. The push application 847 of the WTA server 836 creates a push command, for example, to accept call. The accept call process may be located in the WTAI private library 852. The fact that the accept call process is in the WTAI private library 852 may require that a WTA server be used to access this function where the accept call function is restricted to only being accessed by the WTA server 836. The push application 847 transmits the push command to the WTA user-agent 854 of the target mobile terminal 850 identified by the target mobile terminal contact number in the request.

The WTA server 836 notifies the CSC 820 using the notification application 848 that the push command has been sent to the WTA user-agent 854 of the mobile terminal 850. The CSC 820 initiates a call to the target mobile terminal 850 using the contact number provided in the request. The initiation of the call in the CSC 820 may be performed automatically by the applications server 834 or may be performed manually by a Customer Service Representative who may be notified by the applications server 834 to initiate the call to the target mobile terminal. The target mobile terminal 850 may then automatically answer the call from the CSC 820 without any user intervention. The communication between the server 830 and the mobile terminal 850 may be through the mobile network 810 via the WAP gateway although it is shown as direct in FIG. 8 to simplify the illustration.

Operations according to embodiments of the present invention for requesting WTA protocol based actions will now be further described with reference to the flow chart illustration of FIG. 9. Operations begin at block 900 with receipt of a request from a request center for execution of the WTA protocol based action by a target mobile terminal having a WTA user-agent. This request may be received, for example, from a mobile terminal, a PSTN phone, a source on the internet or the like. In embodiments of the present invention, the WTA protocol based action may be automatically, without any user intervention, accepting a call at the target mobile terminal. If this is the case, the request may include the contact number of the target mobile terminal. The request center may be a customer service center (CSC) that has access to an applications server. The applications server may be part of the CSC, a separate component, or a part of the WTA server. The applications server may receive the request for execution of the WTA protocol based action and forward the request to the WTA server.

The WTA server may generate a push command selecting a state of the target mobile terminal based on the requested WTA protocol based action (block 910). In some embodiments of the present invention, the state of the target mobile terminal may be an accept call state. The accept call state may be activated by an accept call command located in the Wireless Telephony Application Interface (WTAI) private library.

The WTA server transmits the push command to the WTA agent of the target mobile terminal (block 920) and notifies the request center (CSC) that the push command has been transmitted to the WTA agent of the target mobile terminal (block 930). A communication is initiated between the target mobile terminal and the CSC (block 940). The communication may be initiated by an application executing on an applications server or performed by a user at the request center responsive to a notification generated by an application executing on the applications server that indicates to the user that the communication should be initiated. The WTA protocol based action may be initiated at the target mobile terminal in response to the communication from the request center to the target mobile terminal (block 950).

Operations according to embodiments of the present invention for requesting WTA protocol based action will now be further described with reference to the flowchart illustration of FIG. 10. Operations begin at block 1000 with receipt of a request from a request center for execution of the WTA protocol based action by a target mobile terminal having a WTA user-agent. The WTA server may generate a push command selecting a state of the target mobile terminal based on the requested WTA protocol based action (block 1010). The details associated with blocks 1000 and 1010 are discussed above with respect to blocks 900 and 910 of FIG. 9. As shown in FIG. 10, an authentication may be initiated between the WTA server and the target mobile terminal (block 1020). This may ensure that the appropriate security is in place to guarantee that the Push command is from a trusted source.

It is determined if a WAP session has been initiated (block 1030). If a WAP session has not been initiated, a WAP session is initiated (block 1040). The WAP session may be initiated by sending a Session Initiation Application (SIA) to the WTA user-agent of the target mobile terminal and the WTA agent initiates the WAP session in response to the SIA.

If the WAP session is already in progress, operations proceed to block 1050. The WTA server transmits the Push command as discussed above (block 1050). The WTA server transmits a Service Load (SL) push command to the WTA user agent of the target mobile terminal using the WAP session (block 1060). The SL push may include a URL. The URL is accessed by the WTA agent (block 1070). The URL may be associated with a script that executes an accept call command. The accept call command may be associated with a WTAI private library.

The WTA server notifies the request center (CSC) that the push command has been transmitted to the WTA agent of the target mobile terminal (block 1080). A communication is initiated between the target mobile terminal and the CSC (block 1090). Typically it is desirable to synchronize the events that take place between the CSC and the target mobile terminal. The processes for synchronizing events in a wireless network are known to those of skill in the art and will not be discussed further herein. The WTA protocol based action may be initiated at the target mobile terminal in response to the communication from the request center to the target mobile terminal (block 1095). Operations associated with blocks 1080 and 1095 are generally discussed above with respect to blocks 930 through 950 of FIG. 9.

The CSC may obtain information from the target mobile (block 1097). This information may be positioning information provided by a Global Positioning System (GPS) or a land based automated positioning system associated with the target mobile terminal, an image provided by a digital camera device associated with the target mobile terminal, and/or any combination thereof.

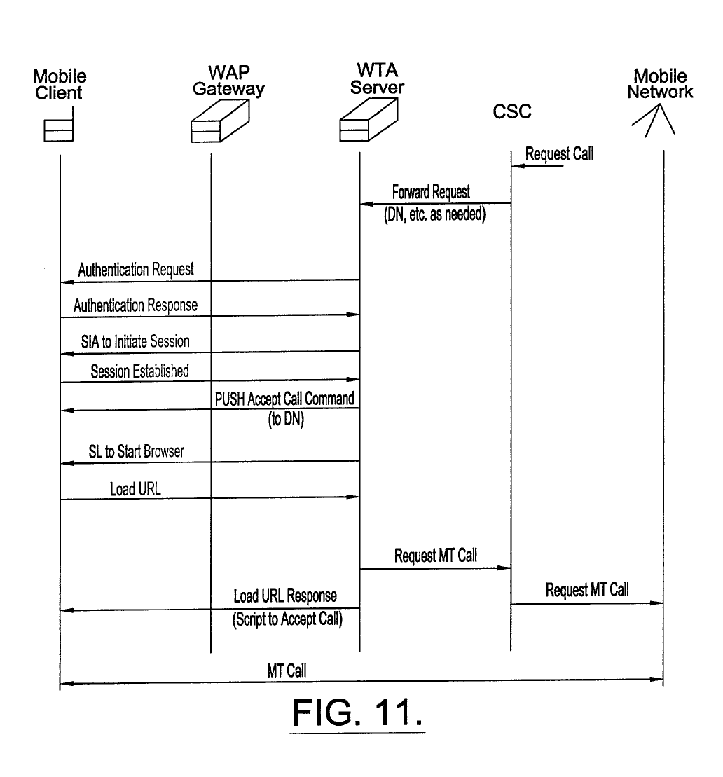

Operations according to embodiments of the present invention for requesting WTA protocol based actions are further illustrated in the flow diagram of FIG. 11. The flow diagram illustrates operations of embodiments of the present invention from receiving a request for WTA protocol based action to initiating the of the WTA protocol based action. The details of each of the steps in the flow diagram of FIG. 11 correspond to the description above with reference to FIGS. 9 and 10.

Operations of the present invention have been described with respect to the block diagram illustration of FIGS. 1 through 4 and 8 and the flowchart illustrations of FIGS. 5 through 7 and 9 through 11. It will be understood that each block of the flowchart illustrations and the block diagram illustrations of FIGS. 1 through 11, and combinations of blocks in the flowchart illustrations and the block diagram illustrations, can be implemented by computer program instructions. These program instructions may be provided to a processor to produce a machine, such that the instructions which execute on the processor create means for implementing the functions specified in the flowchart and block diagram block or blocks. The computer program instructions may be executed by a processor to cause a series of operational steps to be performed by the processor to produce a computer implemented process such that the instructions which execute on the processor provide steps for implementing the functions specified in the flowchart and block diagram block or blocks.

Accordingly, blocks of the flowchart illustrations and the block diagrams support combinations of means for performing the specified functions, combinations of steps for performing the specified functions and program instruction means for performing the specified functions. It will also be understood that each block of the flowchart illustrations and block diagrams, and combinations of blocks in the flowchart illustrations and block diagrams, can be implemented by special purpose hardware-based systems which perform the specified functions or steps, or combinations of special purpose hardware and computer instructions. For example, the I/O circuit 374 may be implemented as code executing on a processor, as integrated circuit devices, such as signal processors or custom chips, or as a combination of the above.

The flowcharts and block diagrams of FIGS. 1 through 11 illustrate the architecture, functionality, and operation of possible implementations of systems, methods and computer program products for requesting Wireless Telephony Application (WTA) Protocol based actions according to various embodiments of the present invention. In this regard, each block in the flow charts or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved.

In the drawings and specification, there have been disclosed typical illustrative embodiments of the invention and, although specific terms are employed, they are used in a generic and descriptive sense only and not for purposes of limitation, the scope of the invention being set forth in the following claims.

What is claimed is:

1. A method for requesting Wireless Telephony Application (WTA) protocol based actions, the method comprising:
receiving a request for execution of the WTA protocol based action by a target mobile terminal having a WTA agent, the request including an identification code that identifies a destination device for the WTA protocol based action;
associating a Uniform Resource Locator (URL) with the identification code that identifies the destination device;
generating at a server a push command including the associated URL; and
transmitting the push command to the target mobile terminal to initiate the requested WTA protocol based action by the WTA agent of the target mobile terminal.

2. The method of claim 1, wherein the server comprises one of an applications server and a WTA server.

3. The method of claim 1, wherein the WTA protocol based action comprises initiation of a call from the target mobile terminal to the destination device.

4. The method of claim 3, wherein the identification code that identifies the destination device comprises a contact number and wherein the request for execution of the WTA protocol based action further comprises:
a contact number of the target mobile terminal; and
a desired start time of a first call.

5. The method of claim 4, wherein the WTA protocol based action comprises successive initiations of calls from the target mobile terminal to the destination device and wherein transmitting the push command to the target mobile terminal comprises repeatedly transmitting the push command to the target mobile according to an interval specified by the request for execution of the WTA protocol based action.

6. The method of claim 5, wherein the interval specified by the request for execution of the WTA protocol based action is a periodic interval.

7. The method of claim 5, wherein the request for execution of the WTA protocol based action further comprises an indication of when execution of the calls should terminate.

8. The method of claim 7, wherein the indication of when execution of the calls should terminate comprises a stop time.

9. The method of claim 7, wherein the indication of when the execution of the calls should terminate comprises a number of calls to be made.

10. The method of claim 1, wherein the URL is associated with a script stored by the server, the script initiating execution of the WTA protocol based action.

11. The method of claim 10, wherein the WTA protocol based action comprises initiation of a call from the target mobile terminal to the destination device and wherein the target mobile terminal receives the script and executes a make call command in the WTA user agent of the target mobile terminal responsive to receipt of the script.

12. The method of claim 11, wherein the make call command is associated with the Wireless Telephony Application Interface (WTAI) public library.

13. The method of claim 1, wherein the association of the URL with the identification code that identifies the destination device is performed by an application executing on an applications server.

14. The method of claim 13, wherein the applications server is the server generating the push command.

15. The method of claim 1, wherein the push command comprises:
a pointer to a Push Proxy Gateway (PPG) of the target mobile terminal;
an identifier of a contact number of the target mobile terminal;
a pointer to the WTA user agent of the target mobile terminal; and
the URL.

16. The method of claim 15, wherein the URL is associated with a script, stored at the server, the script initiating execution of the WTA protocol based actions.

17. The method of claim 1, wherein transmitting the push command to the target mobile terminal further comprises transmitting the push command to a Push Proxy Gateway (PPG) of the target mobile terminal and wherein the following are performed by the PPG:
initiating an authentication between the server and the target mobile terminal;
determining if a Wireless Application Protocol (WAP) session has been initiated;
initiating the WAP session if the WAP session has not been initiated; and
transmitting a Service Load (SL) push command to the WTA user agent of the target mobile terminal using the WAP session wherein the SL push command includes the URL.

18. The method of claim 17, wherein transmitting the push command to the target mobile terminal is followed by accessing the URL in the WTA agent wherein the URL is associated with a script that executes a make call command associated with the WTAI public library and initiating the WTA protocol based action; and wherein the WTA protocol based action comprises initiation of a call from the target mobile terminal to the destination device.

19. The method of claim 17, wherein initiating the WAP session comprises sending a Session Initiation Application (SIA) to the WTA agent and wherein the WTA agent initiates the WAP session responsive to the SIA.

20. A method for requesting Wireless Telephony Application (WTA) protocol based actions, the method comprising:
receiving from a request center a request for execution of the WTA protocol based action by a target mobile terminal having a WTA agent;
generating at a WTA server a push command selecting a state of the target mobile terminal based on the requested WTA protocol based action;
transmitting the push command to the WTA agent of the target mobile terminal; and
notifying the request center that the push command has been transmitted to the WTA agent of the target mobile terminal.

21. The method of claim 20, wherein the request for execution of the WTA protocol based action comprises a contact number of the target mobile terminal.

22. The method of claim 20, wherein the WTA protocol based action comprises automatically accepting a call at the target mobile terminal.

23. The method of claim 20, wherein the request center comprises a customer service center having an applications server and wherein the applications server receives the request for execution of the WTA protocol based action and forwards the request to the WTA server.

24. The method of claim 20, further comprising:
initiating a communication from the request center to the target mobile terminal; and
initiating at the target mobile terminal the WTA protocol based action responsive to the communication from the request center to the target mobile terminal.

25. The method of claim 24, wherein initiating a communication from the request center to the target mobile terminal is performed by an application executing on the applications server.

26. The method of claim 24, wherein initiating a communication from the request center to the target mobile terminal is performed at the request center responsive to a notification generated by an application executing on the applications server that indicates to the request representative that the communication should be initiated.

27. The method of claim 20 wherein the state of the target mobile terminal is an accept call state and wherein the accept call state is activated by an accept call command located in the Wireless Telephony Application Interface (WTAI) private library.

28. The method of claim 20, wherein transmitting the push command to the WTA agent of the target mobile terminal is preceded by:
initiating an authentication between the WTA server and the target mobile terminal;
determining if a Wireless Application Protocol (WAP) session has been initiated; and
initiating the WAP session if WAP session has not been initiated; and wherein transmitting the push command to the WTA agent of the target mobile terminal is followed by:
transmitting a Service Load (SL) push command to the WTA user agent of the target mobile terminal using the WAP session wherein the SL push includes a URL; and
accessing a URL in the WTA agent wherein the URL is associated with a script that executes an accept call command associated with a Wireless Telephony Application Interface (WTAI) private library.

29. The method of claim 28, wherein accessing the URL is followed by automatically accepting a call at the target mobile terminal.

30. The method of claim 28, wherein initiating the WAP session comprises sending a Session Initiation Application (SIA) to the WTA agent and wherein the WTA agent initiates the WAP session responsive to the SIA.

31. The method of claim 20, wherein the push command comprises an accept call command associated with a Wireless Telephony Application Interface (WTAI) private library.

32. The method of claim 20 wherein initiating at the target mobile terminal the WTA protocol based action is followed by obtaining information from the target mobile.

33. The method of claim 32, wherein the information comprises positioning information provided by at least one of a Global Positioning System (GPS) associated with the target mobile terminal and a land based automated positioning system associated with the target mobile terminal.

34. The method of claim 32, wherein the information comprises an image provided by a digital camera device associated with the target mobile terminal.

35. A system for requesting Wireless Telephony Application (WTA) protocol based actions, comprising:
a server that receives a request for execution of the WTA protocol based action by a target mobile terminal having a WTA agent, the request including an identification code that identifies a destination device for the WTA protocol based action;
an association application that associates a Uniform Resource Locator (URL) with the identification code that identifies the destination device;
a push application executing on the server that generates a push command including the associated URL and transmits the push command to the target mobile terminal to initiate the requested WTA protocol based action by the WTA agent of the target mobile terminal.

36. The system according to claim 35, wherein the server comprises one of an applications server and a WTA server.

37. The system according to claim 35, wherein the WTA protocol based action comprises initiation of a call from the target mobile terminal to the destination device.

38. The system according to claim 37, wherein the identification code that identifies the destination device comprises a contact number and wherein the request for execution of the WTA protocol based action further comprises:
a contact number of the target mobile terminal; and
a desired start time of a first call.

39. The system according to claim 38, wherein the WTA protocol based action comprises successive initiations of calls from the target mobile terminal to the destination device and wherein the push application repeatedly transmits the push command to the target mobile according to an interval specified by the request for execution of the WTA protocol based action.

40. The system according to claim 39, wherein the interval specified by the request for execution of the WTA protocol based action is periodic.

41. The system according to claim 40, wherein the request for execution of the WTA protocol based action further comprises an indication of when execution of the calls should terminate.

42. The system according to claim 41, wherein the indication of when execution of the calls should terminate comprises a stop time.

43. The system according to claim 42, wherein the indication of when the execution of the calls should terminate comprises a number of calls to be made.

44. The system according to claim 35, wherein the association application associates a URL with a script stored by the server, the script initiating execution of the WTA protocol based action.

45. The system according to claim 44, wherein the WTA protocol based action comprises initiation of a call from the target mobile terminal to the destination device and wherein the target mobile terminal receives the script and executes a make call command in the WTA user agent of the target mobile terminal responsive to receipt of the script.

46. The system according to claim 45, wherein the make call command is associated with the Wireless Telephony Application Interface (WTAI) public library.

47. The system according to claim 35, wherein the association application that associates the URL with the identification code that identifies the destination device executes on an applications server.

48. The system according to claim 47, wherein the push application that generates the push command executes on the applications server.

49. The system according to claim 48, wherein the push command comprises:
a pointer to a Push Proxy Gateway (PPG) of the target mobile terminal;
an identifier of a contact number of the target mobile terminal;
a pointer to the WTA user agent of the target mobile terminal; and
the URL.

50. The system according to claim 49, wherein the association application associates the URL with a script, stored at the server, the script initiating execution of the WTA protocol based actions.

51. The system according to claim 35, wherein the push application transmits the push command to a Push Proxy Gateway (PPG) of the target mobile terminal and wherein the following are performed by the PPG:
means for initiating an authentication between the server and the target mobile terminal;
means for determining if a Wireless Application Protocol (WAP) session has been initiated;
means for initiating the WAP session if the WAP session has not been initiated; and
means for transmitting a Service Load (SL) push command to the WTA user agent of the target mobile terminal using the WAP session wherein the SL push command includes the URL.

52. The system according to claim 51, wherein the WTA agent receives a script and executes a make call command associated with the WTAI public library maintained by the WTA agent responsive to the URL; and wherein the WTA agent of the target mobile terminal is configured to initiate the WTA protocol based action responsive to the SL push.

53. The system according to claim 52, wherein the WTA protocol based action comprises initiation of a call from the target mobile terminal to the destination device.

54. The system according to claim 53, wherein the means for initiating the WAP session comprises means for sending a Session Initiation Application (SIA) to the WTA agent and wherein the WTA agent is configured to initiate the WAP session responsive to the SIA.

55. A system for requesting Wireless Telephony Application (WTA) protocol based actions, comprising:
a receiving server that receives from a request center a request for execution of the WTA protocol based action by a target mobile terminal having a WTA agent;
a push application executing on a WTA server that generates a push command selecting a state of the target mobile terminal based on the requested WTA protocol based action and transmits the push command to the WTA agent of the target mobile terminal; and
a notification application executing on the WTA server that transmits a notification of transmission of the push command to the WTA agent of the target mobile terminal.

56. The system according to claim 55, wherein the request for execution of the WTA protocol based action comprises a contact number of the target mobile terminal.

57. The system according to claim 55, wherein the WTA protocol based action comprises automatically accepting a call at the target mobile terminal.

58. The system according to claim 55, wherein the notification of transmission of the push command initiates a communication from the request center to the target mobile terminal; and wherein the WTA agent of the target mobile terminal is configured to initiate at the target mobile terminal the WTA protocol based action responsive to the communication from the request center to the target mobile device.

59. The system according to claim 58 wherein the request center comprises a customer service center having an applications server and wherein the applications server is the receiving server that receives the request for execution of the WTA protocol based action and forwards the request to the WTA server.

60. The system according to claim 59, further comprising an application executing on the applications server that initiates the communication from the request center to the target mobile terminal responsive to the notification of transmission of the push command.

61. The system according to claim 57, further comprising an application executing on the applications server that notifies the request representative to initiate the communication.

62. The system according to claim 55, wherein the state of the target mobile terminal is an accept call state and wherein the accept call state is activated by an accept call command located in the Wireless Telephony Application Interface (WTAI) private library responsive to the push command.

63. The system according to claim 55, wherein the WTA server, responsive to the request from the request center, is configured to initiate an authentication between the WTA server and the target mobile terminal, determine if a Wireless Application Protocol (WAP) session has been initiated, and initiate the WAP session if the WAP session has not been initiated; and wherein the WTA server is further configured to transmit, responsive to the push command, a Service Load (SL) push command including a URL to the WTA user agent of the target mobile terminal using the WAP session; and wherein the WTA agent of the target mobile terminal is configured to access the URL responsive to the push command wherein the URL is associated with a script that executes an accept call command associated with a Wireless Telephony Application Interface (WTAI) private library.

64. The system according to claim 63, wherein the accept call command initiates the WTA protocol based action at the target mobile terminal.

65. The system according to claim 63, wherein the WTA server is configured to send a Session Initiation Application (SIA) to the WTA agent responsive to the push command and wherein the WTA agent is configured to initiate the WAP session responsive to the SIA.

66. The system according to claim 55, wherein the push command comprises an accept call command associated with a Wireless Telephony Application Interface (WTAI) private library.

67. The system according to claim 55, wherein the request center comprises an application executing on an applications server that is configured to receive a communication from the target mobile.

68. The system according to claim 67, wherein the received communication from the target mobile terminal comprises positioning information provided by at least one of a Global Positioning System (GPS) associated with the target mobile terminal and a land based automated positioning system associated with the target mobile terminal.

69. The system according to claim 67, wherein the received information from the target mobile terminal comprises an image provided by a digital camera device associated with the target mobile terminal.

70. The system according to claim 55, wherein the receiving server is the WTA server.

71. A system for requesting Wireless Telephony Application (WTA) protocol based actions, the comprising:
means for receiving a request for execution of the WTA protocol based action by a target mobile terminal having a WTA agent, the request including an identification code that identifies a destination device for the WTA protocol based action;
means for associating a Uniform Resource Locator (URL) with the identification code that identifies the destination device;
means for generating at a server a push command including the associated URL; and
means for transmitting the push command to the target mobile terminal to initiate the requested WTA protocol based action by the WTA agent of the target mobile terminal.

72. A system for requesting Wireless Telephony Application (WTA) protocol based actions, the method comprising:
means for receiving from a request center a request for execution of the WTA protocol based action by a target mobile terminal having a WTA agent;
means for generating at a WTA server a push command selecting a state of the target mobile terminal based on the requested WTA protocol based action;
means for transmitting the push command to the WTA agent of the target mobile terminal; and
means for notifying the request center that the push command has been transmitted to the WTA agent of the target mobile terminal.

73. A computer program product for requesting Wireless Telephony Application (WTA) protocol based actions, comprising:
a computer readable program medium having computer readable code embodied therein, the computer readable code comprising:
computer readable program code which receives a request for execution of the WTA protocol based action by a target mobile terminal having a WTA agent, the request including an identification code that identifies a destination device for the WTA protocol based action;
computer readable program code which associates a Uniform Resource Locator (URL) with the identification code that identifies the destination device;
computer readable program code which generates at a server a push command including the associated URL; and
computer readable program code which transmits the push command to the target mobile terminal to initiate the requested WTA protocol based action by the WTA agent of the target mobile terminal.

74. A computer program product for requesting Wireless Telephony Application (WTA) protocol based actions, comprising:
a computer readable program medium having computer readable code embodied therein, the computer readable code comprising:
computer readable program code which receives from a request center a request for execution of the WTA protocol based action by a target mobile terminal having a WTA agent;
computer readable program code which generates at a WTA server a push command selecting a state of the target mobile terminal based on the requested WTA protocol based action;
computer readable program code which transmits the push command to the WTA agent of the target mobile terminal;
computer readable program code which notifies the request center that the push command has been transmitted to the WTA agent of the target mobile terminal.
